(19) United States
(12) Patent Application Publication
(10) Pub. No.: US 2026/0162425 A1
(43) Pub. Date: Jun. 11, 2026

(54) IMAGE PROCESSING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Ziguang NIU, Shenzhen (CN)

(73) Assignee: TENCENT TECHNOLOGY (SHENZHEN) COMPANY LIMITED, Shenzhen (CN)

(21) Appl. No.: 19/038,844

(22) Filed: Jan. 28, 2025

Related U.S. Application Data
(63) Continuation of application No. PCT/CN2023/129446, filed on Nov. 2, 2023.

(30) Foreign Application Priority Data
Jan. 11, 2023 (CN) 202310066903.9

(51) Int. Cl. G06V 20/10; G01C 21/36; G06T 7/73; G06V 10/26; G06V 10/40; G06V 10/764; G06V 10/774; G06V 10/82; G06V 20/13

(52) U.S. Cl. CPC G06V 20/182; G01C 21/3602; G01C 21/3658; G01C 21/3667; G06T 7/74; G06V 10/26; G06V 10/40; G06V 10/764; G06V 10/774; G06V 10/82; G06V 20/13; G06T 2207/10032; G06T 2207/20081; G06T 2207/20084

(57) ABSTRACT

An image processing method, executed by an electronic device, includes obtaining a live-view road image including road imaging information within a geographic range, and obtaining a road network image including a road topology structure within the geographic range; obtaining a to-be-recognized image by combining the road network image and the live-view road image; obtaining a to-be-recognized feature by performing feature extraction on the to-be-recognized image; obtaining road surface information, within the geographic range, including road surface association information, by performing road surface recognition based on the to-be-recognized feature; and performing at least one from among rendering a road within the geographic range based on the road surface information, and displaying a navigation guidance sign on the rendered road; and determining positioning information based on the road surface information, wherein the positioning information is a lane location

### CROSS-REFERENCE TO RELATED APPLICATIONS

This application is a continuation application of International Application No. PCT/CN 2023/129446 filed on Nov. 2, 2023, which claims priority to Chinese Patent Application No. 202310066903.9, filed with the China National Intellectual Property Administration on Jan. 11, 2023, the disclosures of each being incorporated by reference herein in their entireties.

### FIELD

This application relates to image processing technologies in the field of computer application, and in particular, to an image processing method and apparatus, an electronic device, a computer-readable storage medium, and a computer program product.

### BACKGROUND

Image processing usually involves obtaining of road surface information, e.g., a process of obtaining related information of a road surface from an image. The road surface information may be obtained by processing a live-view image of a road. However, the road is usually blocked in the live-view image of the road, and connectivity of the road in the live-view image is affected. As a result, accuracy of the obtained road surface information is affected.

### SUMMARY

According to an aspect of the disclosure, an image processing method, executed by an electronic device, includes obtaining a live-view road image including road imaging information within a geographic range, and obtaining a road network image including a road topology structure within the geographic range; obtaining a to-be-recognized image by combining the road network image and the live-view road image; obtaining a to-be-recognized feature by performing feature extraction on the to-be-recognized image; obtaining road surface information, within the geographic range, including road surface association information, by performing road surface recognition based on the to-be-recognized feature; and performing at least one from among rendering a road within the geographic range based on the road surface information, and displaying a navigation guidance sign on the rendered road; and determining positioning information based on the road surface information, wherein the positioning information is a lane location.

According to an aspect of the disclosure, an image processing apparatus includes, at least one memory configured to store computer program code; and at least one processor configured to read the program code and operate as instructed by the program code, the program code including image obtaining code configured to cause at least one of the at least one processor to obtain a live-view road image including road imaging information within a geographic range; and obtain a road network image including a road topology structure within the geographic range; image combination code configured to cause at least one of the at least one processor to obtain a to-be-recognized image by combining the road network image and the live-view road image; feature extraction code configured to cause at least one of the at least one processor to obtain a to-be-recognized feature by performing feature extraction on the to-be-recognized image; information recognition code configured to cause at least one of the at least one processor to obtain road surface information, within the geographic range, including road surface association information, by performing road surface recognition based on the to-be-recognized feature; and performing code configured to cause at least one of the at least one processor to render a road within the geographic range based on the road surface information, and output, to a display, a navigation guidance sign on the rendered road; or determine positioning information based on the road surface information, wherein the positioning information is a lane location.

According to an aspect of the disclosure, a non-transitory computer-readable storage medium, storing computer code which, when executed by at least one processor, causes the at least one processor to at least obtain a live-view road image including road imaging information within a geographic range, and obtain a road network image including a road topology structure within the geographic range; obtain a to-be-recognized image by combining the road network image and the live-view road image; obtain a to-be-recognized feature by performing feature extraction on the to-be-recognized image; obtain road surface information, within the geographic range, including road surface association information, by performing road surface recognition based on the to-be-recognized feature, wherein the computer code, when executed by the at least one processor, further causes the at least one processor to render a road within the geographic range based on the road surface information, and output, to a display, a navigation guidance sign on the rendered road; or determine positioning information based on the road surface information, wherein the positioning information is a lane location.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an architecture of an image processing system according to some embodiments.

FIG. 2 is a schematic diagram of a structure of a server in FIG. 1 according to some embodiments.

FIG. 3 is a schematic flowchart 1 of an image processing method according to some embodiments.

FIG. 4 is an example road network image according to some embodiments.

FIG. 5 is an example schematic flowchart of obtaining a road network image according to some embodiments.

FIG. 6 is a schematic flowchart 2 of an image processing method according to some embodiments.

FIG. 7 is a schematic flowchart of obtaining a target instance feature according to some embodiments.

FIG. 8 is an example schematic flowchart of obtaining a road recognition model according to some embodiments.

FIG. 9 is a schematic flowchart 3 of an image processing method according to some embodiments.

FIG. 10 is an example schematic diagram of obtaining road surface information according to some embodiments.

FIG. 11 is an example diagram of a network structure of a module according to some embodiments.

FIG. 12 is an example schematic diagram of a result of obtaining a road surface according to some embodiments.

FIG. 13 is an example schematic diagram of application of road surface information according to some embodiments.

FIG. 14 is another example schematic diagram of application of road surface information according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The term “first\second” involved in the following descriptions is for distinguishing similar objects, and does not represent an order of the objects. “First\second” may be interchanged in an order or sequence when permitted, so that some embodiments described herein can be performed in a sequence other than those illustrated or described herein.

Unless otherwise defined, all technical and scientific terms used in disclosure have same meanings as those commonly understood by a person skilled in the art belonging to this application. Terms used in the disclosure are only intended to describe exemplary embodiments and are not intended to limit the scope of the disclosure.

Before some embodiments are described, nouns and terms involved in the disclosure are described. The nouns and terms are subject to the following explanations.
(1) Artificial intelligence (AI) is a theory, a method, a technology, and an application system that use a digital computer or a machine controlled by the digital computer to simulate, extend, and expand human intelligence, perceive an environment, obtain knowledge, and use the knowledge to obtain an optimal result.
(2) Machine learning (ML) is a discipline in which a plurality of fields intersect, and relates to a plurality of disciplines such as a probability theory, statistics, an approximation theory, convex analysis, and a computational complexity theory. The machine learning is for studying how a computer simulates or implements a human learning behavior, to obtain new knowledge or a new skill, and reorganize an existing knowledge structure, so that performance of the computer is continuously improved. The machine learning is a core of artificial intelligence, a basic manner to make a computer intelligent, and is applied to various fields of the artificial intelligence. The machine learning usually includes technologies such as an artificial neural network, a belief network, reinforcement learning, transfer learning, and inductive learning.
(3) An artificial neural network is a mathematical model that imitates a structure and a function of a biological neural network. An example structure of the artificial neural network in some embodiments may include a graph convolutional network (GCN, which is a neural network for processing data of a graph structure), a deep neural network (DNN), a convolutional neural network (CNN), a recurrent neural network (RNN), a neural state machine (NSM), a phase-functioned neural network (PFNN), and the like. A road recognition model, a to-be-trained model, and a target road recognition model that are involved in some embodiments are all models corresponding to the artificial neural network.
(4) Road network information is also referred to as standard definition (SD) road network information. The road network information is an abstract representation of a road in the real world, and describes topological connectivity of the road. In some embodiments, the road network information may be standard definition (which is lower than specified accuracy) road association information collected on site.
(5) A road surface refers to a road between two intersection nodes that is for passing (for example, traveling by a vehicle and walking by a pedestrian). In addition, there is no physical separation (for example, a green belt or a fence) or logical separation (for example, double yellow lines) on one road surface, and passing objects travel or walk in a same direction. Association information of the road surface is referred to as road surface information. Some roads include one road surface (for example, a one-way road), some roads include two road surfaces, and the like. However, the disclosure is not limited thereto.

To obtain road surface information, a live-view image of a road may be processed to obtain the road surface information. However, the road is usually blocked in the live-view image of the road due to factors such as light, a shadow, and blocking by trees, and connectivity of the road in the live-view image is affected. Consequently, a part of a road surface cannot be recognized. As a result, accuracy of the obtained road surface information is affected.

To obtain the road surface information, geometric information in road network information may be expanded by a specified width according to a specified policy, to obtain the road surface information. In this way, although the connectivity of the road can be ensured, information included in the road network information is estimated, and the accuracy of the obtained road surface information is affected.

Some embodiments provide an image processing method and apparatus, an electronic device, a computer-readable storage medium, and a computer program product, and can improve the accuracy of the road surface information. Example application of the electronic device for image processing (which is referred to as an image processing device for short below) provided in some embodiments is described below. The image processing device provided in some embodiments may be implemented as various types of terminals such as a smartphone, a smart watch, a notebook computer, a tablet computer, a desktop computer, a smart appliance, a set-top box, a smart vehicle-mounted device, a portable music player, a personal digital assistant, a dedicated message device, a smart voice interaction device, a portable game device, and a smart speaker, or may be implemented as a server. Example application when the image processing device is implemented as a server is described below.

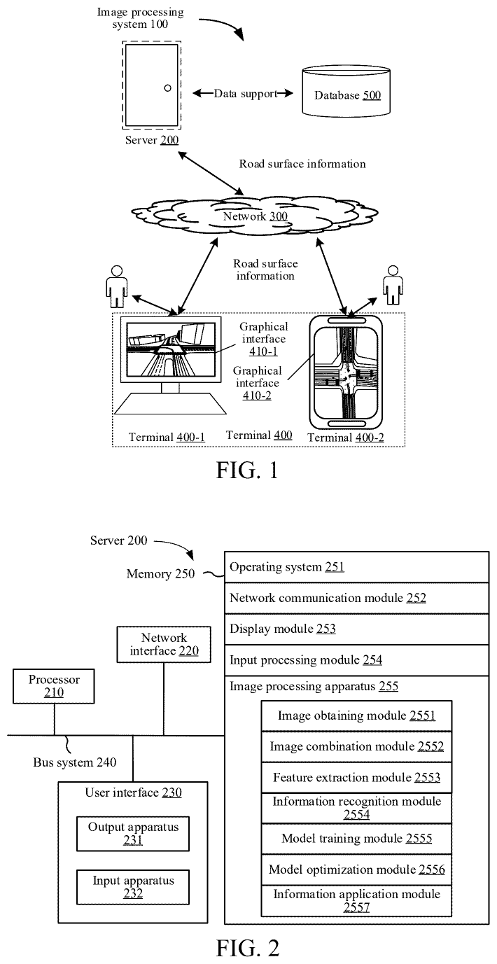

FIG. 1 is a schematic diagram of an architecture of an image processing system according to some embodiments. As shown in FIG. 1, to support an image processing application, in an image processing system 100, a terminal 400 (where a terminal 400-1 and a terminal 400-2 are shown as an example) is connected to a server 200 (which is referred to as an image processing device) through a network 300. The network 300 may be a wide area network, a local area network, or a combination thereof. In addition, the image processing system 100 further includes a database 500 for providing data support to the server 200. In addition, FIG. 1 shows a case in which the database 500 is independent of the server 200. In addition, the database 500 may be integrated in the server 200. However, the disclosure is not limited thereto.

The terminal 400 is configured to render a road within a specified geographic range based on road surface information (for example, content displayed on a graphical interface 410-2), and is further configured to display a navigation guidance sign on the rendered road (for example, content displayed on a graphical interface 410-1).

The server 200 is configured to obtain a live-view road image of the road within the specified geographic range, and obtain a road network image of the road within the specified geographic range, where the road network image includes a topology structure of the road within the specified geographic range, and the live-view road image represents imaging information of the road within the specified geographic range; combine the road network image and the live-view road image, to obtain a to-be-recognized image; perform feature extraction on the to-be-recognized image, to obtain a to-be-recognized feature; and perform road surface recognition based on the to-be-recognized feature, to obtain the road surface information, where the road surface information is road surface association information of the road within the specified geographic range. The server 200 is further configured to send the road surface information to the terminal 400 through the network 300.

In some embodiments, the server 200 may be an independent physical server, a server cluster or distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a smart watch, a notebook computer, a tablet computer, a desktop computer, a smart television, a set-top box, a smart vehicle-mounted device, a portable music player, a personal digital assistant, a dedicated message device, a portable game device, a smart speaker, or the like, but is not limited thereto. The terminal and the server may be connected directly or indirectly in a wired or wireless communication manner. However, the disclosure is not limited thereto.

FIG. 2 is a schematic diagram of a structure of the server in FIG. 1 according to some embodiments. As shown in FIG. 2, the server 200 includes at least one processor 210, a memory 250, and at least one network interface 220. Various components in the server 200 are coupled together by using a bus system 240. The bus system 240 is for implementing connection communication between the components. In addition to a data bus, the bus system 240 further includes a power bus, a control bus, and a state signal bus. However, for clear description, the various buses are denoted as the bus system 240 in FIG. 2.

The processor 210 may be an integrated circuit chip having a signal processing capability, such as a central processing unit (CPU), a digital signal processor (DSP), or another programmable logic device, a discrete gate or transistor logic device, or a discrete hardware component. The processor may be a microprocessor, controller, or the like.

The memory 250 may be removable, non-removable, or a combination thereof. For example, a hardware device includes a solid-state memory, a hard disk drive, or an optical disk drive. In some embodiments, the memory 250 includes one or more storage devices physically located away from the processor 210.

The memory 250 includes a volatile memory or a non-volatile memory, and may include both a volatile memory and a non-volatile memory. The non-volatile memory may be a read-only memory (ROM), and the volatile memory may be a random access memory (RAM).

In some embodiments, the memory 250 can store data to support various operations. An example of the data includes a program, a module, a data structure, or a subsets or superset thereof. Example descriptions are provided below.

An operating system 251 includes a system program for processing various basic system services and executing a hardware-related task, for example, a framework layer, a core library layer, and a driver layer, and is configured to implement various basic services and process a hardware-based task.

A network communication module 252 is configured to reach another electronic device through the one or more (wired or wireless) network interfaces 220. For example, the network interface 220 includes Bluetooth, wireless fidelity (Wi-Fi), and a universal serial bus (USB).

In some embodiments, an image processing apparatus may be implemented via hardware and/or software. FIG. 2 shows an image processing apparatus 255 stored in the memory 250. The image processing apparatus 255 may be software in a form such as a program or a plug-in, and includes the following software modules: an image obtaining module 2551, an image combination module 2552, a feature extraction module 2553, an information recognition module 2554, a model training module 2555, a model optimization module 2556, and an information application module 2557. The modules are logical, so that the modules can be combined or further split arbitrarily based on an implemented function. Functions of the modules are described.

In some embodiments, the image processing apparatus provided in some embodiments may be implemented in hardware. In an example, the image processing apparatus may be a processor in a form of a hardware decoding processor, and is programmed to execute the image processing method provided in some embodiments. For example, the processor in the form of a hardware decoding processor may adopt one or more application-specific integrated circuits (ASICs), DSPs, programmable logic devices (PLDs), complex programmable logic devices (CPLDs), field-programmable gate arrays (FPGAs) or other electronic components.

In some embodiments, the terminal or the server may run a computer program to implement the image processing method provided in some embodiments. For example, the computer program may be a native program or a software module in the operating system, may be a native application (APP), for example, a program to be installed in the operating system for running, such as a map APP, a navigation APP, or a smart city APP, or may be a mini program that can be embedded into any APP, for example, a program that is executable merely when the program is downloaded in a browser environment. In conclusion, the computer program described above may be an application program, a module, or a plug-in of any form.

The image processing method provided in some embodiments is described below with reference to example applications and implementations of the image processing device provided in some embodiments. In addition, the image processing method provided in some embodiments is applied to various image processing scenarios such as a cloud technology, artificial intelligence, intelligent transportation, a map, and a vehicle.

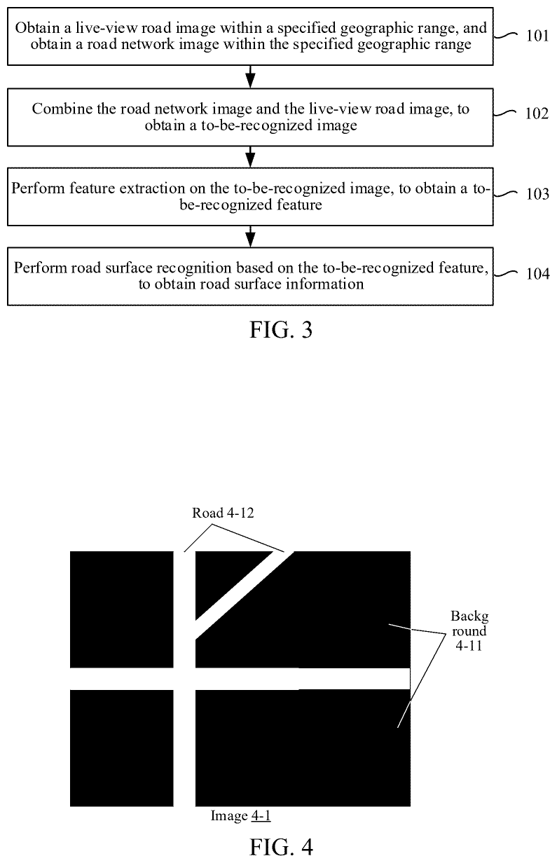

FIG. 3 is a schematic flowchart 1 of an image processing method according to some embodiments. Descriptions are provided below with reference to operations shown in FIG. 3, and an execution body of the operations in FIG. 3 is an image processing device.

Operation 101: Obtain a live-view road image within a specified geographic range, and obtain a road network image within the specified geographic range.

In some embodiments, when the image processing device extracts related information of a road surface for a road within the specified geographic range, the image processing device first obtains the live-view road image and the road network image within the specified geographic range, and extracts the related information of the road surface with reference to the live-view road image and the road network image. The image processing device may obtain the live-view road image by performing image collection on the road within the geographic range. The image collection may be performed in a high-altitude shooting manner, for example, shooting by an unmanned aerial vehicle or satellite imaging. The image processing device may obtain the road network image by performing image generation on road network information within the geographic range.

The road network image includes a road topology structure within the specified geographic range, and describes connectivity of the road within the specified geographic range. For example, FIG. 4 is an example road network image according to some embodiments. As shown in FIG. 4, an image 4-1 is a road network image. A black region represents a background (where a background 4-11 is shown as an example), and a white region represents a location of a road (where a road 4-12 is shown as an example).

The live-view road image represents road imaging information within the specified geographic range. In addition, the road network image and the live-view road image correspond to same geographic ranges, and the same geographic ranges are both the specified geographic range.

Operation 102: Combine the road network image and the live-view road image, to obtain a to-be-recognized image.

In some embodiments, the image processing device extracts the related information of the road surface with reference to the road network image and the live-view road image. Therefore, after obtaining the road network image and the live-view road image, the image processing device combines the road network image and the live-view road image into the to-be-recognized image, to extract the related information of the road surface based on the to-be-recognized image. The road network image and the live-view road image may be combined in a channel splicing manner.

The road network image may be a single-channel image, for example, a gray-scale image. The live-view road image may be a single-channel image or a multi-channel image. When combining the road network image and the live-view road image, the image processing device splices channel information of the road network image and channel information of the live-view road image, to obtain the to-be-recognized image. Therefore, the to-be-recognized image is a multi-modal image, for example, includes both live-view information of the road within the specified range and the road topology structure.

Operation 103: Perform feature extraction on the to-be-recognized image, to obtain a to-be-recognized feature.

In some embodiments, the image processing device performs feature extraction on the to-be-recognized image, and an extracted feature is the to-be-recognized feature. The to-be-recognized feature is for determining the related information of the road surface within the specified geographic range.

In some embodiments, the image processing device may first combine the road network image and the live-view road image, and then perform feature extraction on the to-be-recognized image obtained through combination, to obtain the to-be-recognized feature. The image processing device may first extract a first feature of the road network image, then extract a second feature of the live-view road image, and finally combine the first feature and the second feature to obtain the to-be-recognized feature. However, the disclosure is not limited thereto.

Operation 104: Perform road surface recognition based on the to-be-recognized feature, to obtain road surface information.

In some embodiments, the image processing device performs road surface recognition based on the to-be-recognized feature, to obtain the related information of the road surface within the specified geographic range, and the obtained related information of the road surface within the specified geographic range is referred to as the road surface information.

The road surface information is road surface association information within the specified geographic range. The road surface information includes at least one piece of the following information: a road surface form, a road surface size, a road surface location, a quantity of lanes, a lane width, a lane material, a lane location, a lane form, and a road sign. The road surface form represents a geometric shape of the road surface, for example, a rectangle or a circle. The road surface size is, for example, a width and a length of the road surface, or a radius of the road surface. The road surface location represents a geographic location of the road surface. The quantity of lanes represents a quantity of lanes on the road surface. The lane width represents a width of each lane on the road surface. The lane material represents a laying material of each lane on the road surface. The lane location represents a geographic location of each lane on the road surface. The lane form represents a geometric shape of each lane on the road surface. The road sign includes at least one of the following: a lane sign (for example, a steering sign or a traveling sign) of each lane on the road surface, and a sign (for example, diversion lines) of the road surface.

In a process in which the road surface information of the road within the specified geographic range is obtained, the road surface information is obtained not only based on the live-view road image of the road within the specified geographic range, but also with reference to the road network image of the road within the specified geographic range. The live-view road image can accurately describe information included on the road, and the road network image can completely describe topological connectivity of the road. Therefore, when the road surface information is obtained with reference to the live-view road image and the road network image, the connectivity of the road can be improved while it is ensured that the road surface information is accurate, so that accuracy of the obtained road surface information can be improved.

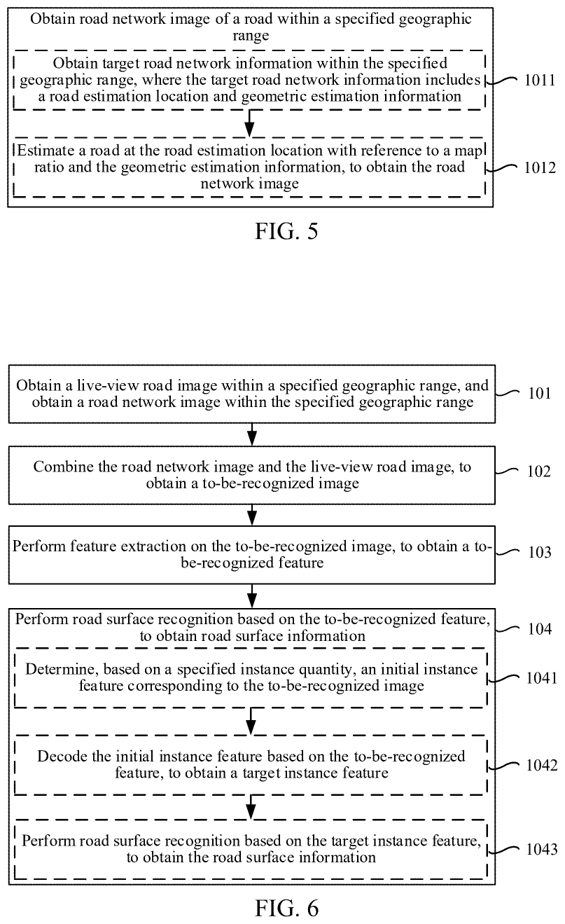

FIG. 5 is an example schematic flowchart of obtaining a road network image according to some embodiments. An execution body of operations in FIG. 5 is the image processing device. As shown in FIG. 5, in some embodiments, that the image processing device obtains the road network image within the specified geographic range in operation 101 in FIG. 3 includes operation 1011 and operation 1012. The operations are separately described below.

Operation 1011: Obtain target road network information within the specified geographic range, where the target road network information includes a road estimation location and geometric estimation information.

In some embodiments, the image processing device can obtain, from a road network information base, road network information matching the road within the specified geographic range. The road network information matching the road within the specified geographic range is referred to as the target road network information. The road network information base includes various pieces of road network information corresponding to various geographic ranges. In addition, the geometric estimation information includes at least one of a lane quantity range, a road width range, and a road level, and is configured for determining an estimated form of the road. The lane quantity range represents a range of a quantity of lanes respectively included in each road within the specified geographic range, for example, two to four lanes. The road width range represents a width range of each road within the specified geographic range, for example, a width of five meters to ten meters. The road level represents a level of each road within the specified geographic range, for example, a first-grade road (corresponding to a width of eight meters to ten meters) or a second-grade road (corresponding to a width of four meters to eight meters).

Operation 1012: Estimate a road at the road estimation location with reference to a map ratio and the geometric estimation information, to obtain the road network image.

In some embodiments, a specified template image is set in the image processing device, or the image processing device can obtain a specified template image from another device (for example, a storage device such as a database). The map ratio exists between the specified template image and an actual geographic location. The image processing device estimates road network information at the road estimation location with reference to the map ratio and the geometric estimation information, for example, estimates, on the specified template image, the road at the road estimation location based on the geometric estimation information, to map the target road network information to the specified template image, so as to obtain the road network image.

The target road network information is converted into the road network image, so that the road surface can be obtained with reference to the live-view road image and the target road network information, to improve the accuracy of the obtained road surface information.

FIG. 6 is a schematic flowchart 2 of an image processing method according to some embodiments. An execution body of operations in FIG. 6 is the image processing device. As shown in FIG. 6, operation 104 in FIG. 3 may be implemented through operation 1041 to operation 1043. In other words, that the image processing device performs road surface recognition based on the to-be-recognized feature, to obtain the road surface information includes operation 1041 to operation 1043. The operations are separately described below.

Operation 1041: Determine, based on a specified instance quantity, an initial instance feature corresponding to the to-be-recognized image.

In some embodiments, the image processing device can obtain the specified instance quantity, or the image processing device can obtain the specified instance quantity from another device (for example, a storage device such as a database or an instruction transmitting device for extracting road surface information). The specified instance quantity represents a quantity of specified road surfaces, and the specified road surface is a preset road surface whose existence is to be determined. Therefore, the specified instance quantity is a maximum quantity of road surfaces included in the preset specified geographic range. The image processing device performs instance-feature initialization on the to-be-recognized image based on the specified instance quantity, to obtain the initial instance feature. The initial instance feature includes initial instance sub-features corresponding to the specified instance quantity, and each of the initial instance sub-features represents a preset feature of the specified road surface.

Operation 1042: Decode the initial instance feature based on the to-be-recognized feature, to obtain a target instance feature.

In some embodiments, the image processing device decodes the initial instance feature based on the to-be-recognized feature, to accurately determine an instance feature of each road surface within the specified geographic range. A decoded initial instance feature is the target instance feature.

The decoding refers to a process of determining, based on the to-be-recognized feature, whether each of the initial instance sub-features is a feature of the road surface. Therefore, the target instance feature represents a road surface feature existing within the specified geographic range.

Operation 1043: Perform road surface recognition based on the target instance feature, to obtain the road surface information.

In some embodiments, the image processing device performs road surface recognition based on the target instance feature, and combines the obtained related information of each road surface into the road surface information within the specified geographic range.

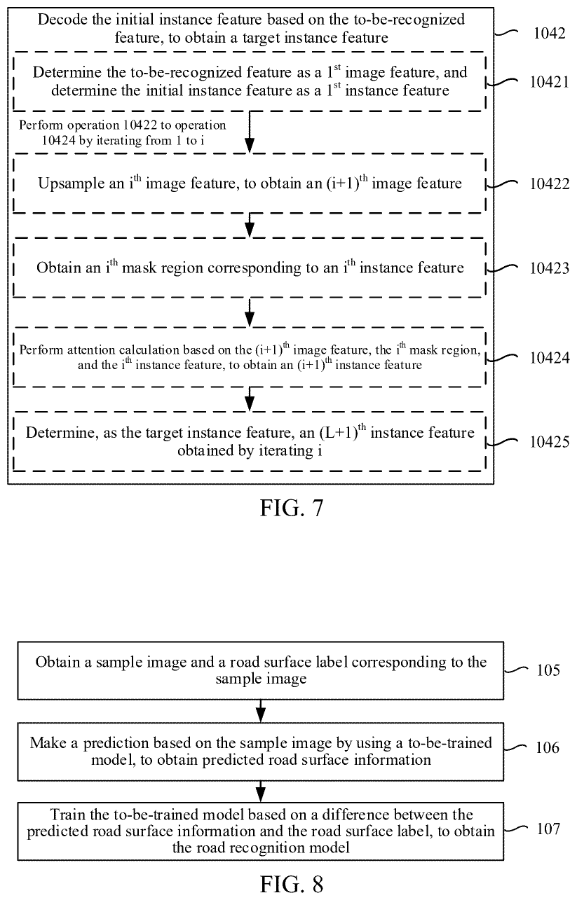

FIG. 7 is a schematic flowchart of obtaining a target instance feature according to some embodiments. An execution body of operations in FIG. 7 is the image processing device. As shown in FIG. 7, operation 1042 in FIG. 6 may be implemented through operation 10421 to operation 10425. In other words, that the image processing device decodes the initial instance feature based on the to-be-recognized feature, to obtain the target instance feature includes operation 10421 to operation 10425. The operations are separately described below.

Operation 10421: Determine the to-be-recognized feature as a 1^{st} image feature, and determine the initial instance feature as a 1^{st} instance feature.

Because the to-be-recognized feature is a basic image feature extracted from the to-be-recognized image, the image processing device determines the to-be-recognized feature as the 1^{st} image feature. Because the initial instance feature is an initialized instance feature, the image processing device determines the initial instance feature as the 1^{st} instance feature.

Operation 10422 to operation 10424 are performed by iterating from 1 to i, where i is a positive integer variable.

Operation 10422: Upsample an i^{th} image feature, to obtain an (i+1)^{th} image feature.

The to-be-recognized feature is a feature that has a low resolution (which is lower than a specified resolution) and a high dimension (which is higher than a specified dimension) and that is extracted from the to-be-recognized image. To use the to-be-recognized feature as a feature assisting in road surface recognition performed based on the initial instance feature, the image processing device gradually upsamples the to-be-recognized feature. Therefore, the image processing device upsamples the i^{th} image feature each time, to obtain the (i+1)^{th} image feature. In other words, the image processing device upsamples the 1^{st} image feature, to obtain a 2^{nd} image feature, then upsamples the 2^{nd} image feature, to obtain a 3^{rd} image feature, and so on until iteration ends.

Operation 10423: Obtain an i^{th} mask region corresponding to an i^{th} instance feature.

When i is 1, the image processing device determines, through initialization, a 1^{st} mask region corresponding to the 1^{st} instance feature. When i is greater than 1, the image processing device predicts the i^{th} mask region corresponding to the i^{th} instance feature.

Operation 10424: Perform attention calculation based on the (i+1)^{th} image feature, the i^{th} mask region, and the i^{th} instance feature, to obtain an (i+1)^{th} instance feature.

After obtaining the (i+1)^{th} image feature and the i^{th} mask region, the image processing device performs attention calculation based on the (i+1)^{th} image feature, the i^{th} mask region, and the i^{th} instance feature, to optimize the i^{th} instance feature and improve accuracy of predicting the i^{th} instance feature. An optimized i^{th} instance feature is the (i+1)^{th} instance feature.

In some embodiments, the attention calculation includes at least one of masked attention calculation, self attention calculation, and feed-forward propagation. The masked attention calculation is for learning a local dependency between each pixel and a mask region. The self attention calculation is for learning global information between each pixel and an entire image. Therefore, when the attention calculation includes the masked attention calculation, the self attention calculation, and the feed-forward propagation, that the image processing device performs attention calculation based on the (i+1)^{th} image feature, the i^{th} mask region, and the i^{th} instance feature, to obtain the (i+1)^{th} instance feature includes: The image processing device performs masked attention calculation based on the (i+1)^{th} image feature, the i^{th} mask region, and the i^{th} instance feature, to obtain an (i+1)^{th} initial feature; performs self attention calculation based on the (i+1)^{th} initial feature, to obtain an (i+1)^{th} to-be-processed feature; and performs feed-forward propagation based on the (i+1)^{th} to-be-processed feature, to obtain the (i+1)^{th} instance feature.

Operation 10425: Determine, as the target instance feature, an (L+1)^{th} instance feature obtained by iterating i.

In some embodiments, the image processing device performs determining once every time i is iterated, to determine whether an iteration end condition is satisfied. When the iteration end condition is not satisfied, the image processing device continues to iterate i to perform operation 10422 to operation 10424. When the iteration end condition is satisfied, the image processing device performs operation 10425.

The iteration end condition may be that a first accuracy indicator threshold is reached, a first iteration quantity threshold is reached, a first iteration duration threshold is reached, a combination thereof is reached, or the like. However, the disclosure is not limited thereto. L represents a quantity of iterations of i, and is a constant. For example, when the iteration is performed once, the target instance feature is a 2^{nd} instance feature. When the iteration is performed thrice, the target instance feature is a 3^{rd} instance feature.

In some embodiments, when the target instance feature is obtained through operation 10421 to operation 10425, that the image processing device performs road surface recognition based on the target instance feature, to obtain the road surface information in operation 1043 in FIG. 6 includes: The image processing device predicts an instance class based on the target instance feature, to obtain a road surface instance; upsamples an (L+1)^{th} image feature, to obtain a target image feature; fuses the target image feature and the target instance feature, to obtain a mask feature; and predicts information about the road surface instance based on the mask feature, to obtain the road surface information. In other words, the image processing device predicts the instance class based on the target instance feature, where the instance class includes at least one of a road surface class and an intersection class; upsamples the (L+1)^{th} image feature, to obtain the target image feature; fuses the target image feature and the target instance feature, to obtain the mask feature; and finally predicts, for the instance class belonging to the road surface class, the road surface information based on the mask feature.

When the image processing device predicts an instance of the road surface class, the image processing device obtains the road surface information. The (L+1)^{th} image feature is obtained by performing L times of iterative upsampling on the 1^{st} image feature. The road surface instance is a feature of the road surface class. The image processing device determines, from the mask feature, a feature corresponding to the road surface instance, and determines the road surface association information based on the determined feature, to determine the road surface information.

In some embodiments, the feature extraction and the road surface recognition are obtained by using a road recognition model. FIG. 8 is an example schematic flowchart of obtaining a road recognition model according to some embodiments. An execution body of operations in FIG. 8 is the image processing device. As shown in FIG. 8, the road recognition model may be obtained through training in operation 105 to operation 107. The operations are separately described below.

Operation 105: Obtain a sample image and a road surface label corresponding to the sample image.

In some embodiments, the image processing device obtains training data, to obtain the sample image and the road surface label corresponding to the sample image. The sample image is obtained based on a sample live-view road image and a sample road network image. The sample live-view road image represents road imaging information within a sample geographic range, and the sample road network image includes a road topology structure within the sample geographic range. In addition, a process in which the image processing device obtains the sample image based on the sample live-view road image and the sample road network image is similar to the process in which the image processing device obtains the to-be-recognized image. The road surface label is label information of the sample image in terms of a road surface, and represents road surface association information within the sample geographic range.

Operation 106: Make a prediction based on the sample image by using a to-be-trained model, to obtain predicted road surface information.

In some embodiments, the image processing device can obtain the to-be-trained model. The to-be-trained model is a to-be-trained neural network model for predicting road surface association information. In addition, the sample image and the road surface label corresponding to the sample image are training data of the to-be-trained model. Therefore, the image processing device predicts the sample image based on the to-be-trained model, to predict road surface association information in the sample image, and determines the predicted road surface association information as the predicted road surface information.

The to-be-trained model may be a constructed original neural network model, a pre-trained neural network model, or the like. However, the disclosure is not limited thereto.

Operation 107: Train the to-be-trained model based on a difference between the predicted road surface information and the road surface label, to obtain the road recognition model.

In some embodiments, the image processing device compares the predicted road surface information with the road surface label, to determine a loss function value of the to-be-trained model based on a difference between the predicted road surface information and the road surface label; and performs back propagation in the to-be-trained model based on the loss function value, to adjust a model parameter in the to-be-trained model. In addition, the to-be-trained model is trained iteratively. When iterative training ends, a current to-be-trained model obtained through the iterative training is the road recognition model.

When determining that the iterative training satisfies a training end condition, the image processing device determines that the iterative training ends. Otherwise, the iterative training continues to be performed. The training end condition may be that a second accuracy indicator threshold is reached, a second iteration quantity threshold is reached, a second iteration duration threshold is reached, a combination thereof is reached, or the like. However, the disclosure is not limited thereto.

In some embodiments, after operation 107 in FIG. 8, a process of optimizing the road recognition model is further included. In other words, after the image processing device trains the to-be-trained model based on the difference between the predicted road surface information and the road surface label, to obtain the road recognition model, the image processing method further includes: The image processing device first obtains a new sample image and a new road surface label corresponding to the new sample image; makes a prediction based on the new sample image by using the road recognition model, to obtain new predicted road surface information; and optimizes the road recognition model based on a difference between the new predicted road surface information and the new road surface label, to obtain a target road recognition model.

The target road recognition model is for predicting road surface association information of a new to-be-recognized image. In addition, a process in which the image processing device obtains the new sample image and the new road surface label corresponding to the new sample image is similar to the process in which the image processing device obtains the sample image and the road surface label corresponding to the sample image. A process in which the image processing device trains the to-be-trained model is similar to the process in which the image processing device optimizes the road recognition model.

After the road recognition model is obtained by training the to-be-trained model, the road recognition model is optimized based on the new sample image to obtain the target road recognition model, so that a generalization capability of the target road recognition model can be improved, and the accuracy of the obtained road surface information can be further improved.

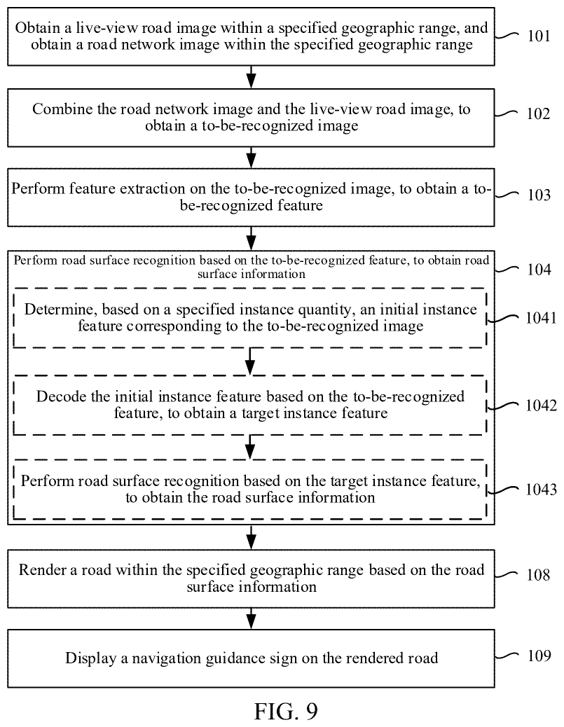

FIG. 9 is a schematic flowchart 3 of an image processing method according to some embodiments. An execution body of operations in FIG. 9 is the image processing device. As shown in FIG. 9, operation 108 and operation 109 are further included after operation 104 in FIG. 3. In other words, after the image processing device performs road surface recognition based on the to-be-recognized feature, to obtain the road surface information, the image processing method further includes operation 108 and operation 109. The operations are separately described below.

Operation 108: Render a road within the specified geographic range based on the road surface information.

In some embodiments, the image processing device is further configured to render the road within the specified geographic range based on the road surface information. Because the road surface information includes at least one of a road surface form, a road surface size, a road surface location, a quantity of lanes, a lane width, a lane material, a lane location, a lane form, and a road sign, the rendered road includes at least one of the road surface form, the road surface size, the road surface location, the quantity of lanes, the lane width, the lane material, the lane location, the lane form, and the road sign.

Operation 109: Display a navigation guidance sign on the rendered road.

In some embodiments, the image processing device may render a smart city based on the rendered road. In addition, the image processing device may further implement accurate navigation based on the rendered road.

The image processing device performs accurate navigation based on information on the rendered road, to display the navigation guidance sign. For example, when the rendered road includes a steering guidance sign, a navigation guidance sign pointing to a lane that can be turned to is displayed on a lane on which the steering guidance sign is located.

In some embodiments, after the image processing device performs road surface recognition based on the to-be-recognized feature, to obtain the road surface information, the image processing method further includes: The image processing device determines positioning information based on the road surface information, where the positioning information is a lane location.

Because the positioning information is a lane location of a road on which a positioning object is located, positioning accuracy of the positioning object can be improved. The positioning object represents an object passing on the road, for example, a pedestrian or a vehicle.

The following describes example application of some embodiments in an actual application scenario. A process in which road surface information is obtained with reference to a satellite image (which is referred to as a live-view road image) and SD road network information (which is referred to as target road network information) of a road is described in this example application.

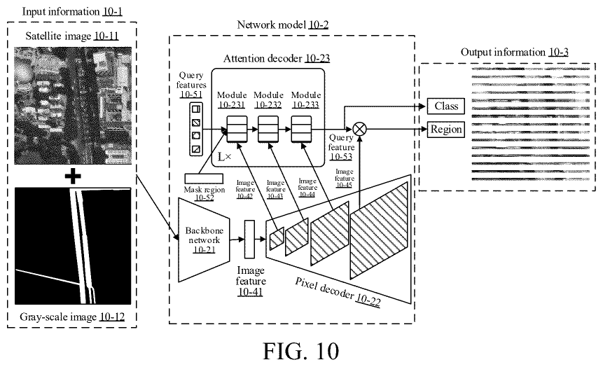

FIG. 10 is an example schematic diagram of obtaining road surface information according to some embodiments. As shown in FIG. 10, after input information 10-1 passes through a network model 10-2 (which is referred to as a road recognition model), output information 10-3 (which is referred to as road surface information) is obtained.

The input information 10-1 includes a satellite image 10-11 in a same geographic range (which is referred to as a specified geographic range) and a gray-scale image 10-12 (which is referred to as a road network image) generated based on the SD road network information, and the satellite image 10-11 and the gray-scale image 10-12 have a same pixel size. The network model 10-2 includes a backbone network 10-21, a pixel decoder 10-22, and an attention decoder (Transformer Decoder) 10-23. The output information 10-3 includes association information of various road surfaces.

Modules of the network model 10-2 are separately described below.

The backbone network 10-21 is configured to extract a feature. The satellite image 10-11 of three channels (red green blue (RGB) channels) and the gray-scale image 10-12 of a single channel are composed into a multi-modal image (which is referred to as a to-be-recognized image) of four channels. The backbone network 10-21 is configured to extract an image feature 10-41 (which is referred to as a to-be-recognized feature) from the multi-modal image of four channels. The image feature 10-41 is an input feature of the pixel decoder 10-22, and the image feature 10-41 is a low-resolution high-dimensional feature. In addition, the backbone network 10-21 includes a residual network (Resnet), an attention module (Swin Transformer), and the like.

The pixel decoder 10-22 is configured to gradually upsample the image feature 10-41, to obtain features that have high resolutions (which are lower than a specified resolution) and low dimensions (which are higher than a specified dimension) and that have different scales (where an image feature 10-42 to an image feature 10-45 are shown as an example, and are referred to as i^{th} image features). The high-resolution low-dimensional feature can improve accuracy of recognizing a road surface.

The attention decoder 10-23 includes a plurality of layers of modules. Modules 10-231 to 10-233 are shown as an example, and are configured to obtain, though decoding, a final query feature 10-53 (which is referred to as an (L+1)^{th} instance feature) with reference to initialized query features 10-51 (which are referred to as initial instance features) of a specified instance quantity, a mask region 10-52 corresponding to the query features 10-51, and the high-resolution low-dimensional features (including the image feature 10-42 to the image feature 10-44) of different scales; predict a class based on the query feature 10-53; and predict a corresponding region (Mask) based on a fusion feature of the query feature 10-53 and the image feature 10-45, to obtain the output information 10-3. A process of obtaining the query feature 10-53 includes L times of cycle processing. Each time of cycle processing includes a plurality of layers of feature processing corresponding to the plurality of layers of modules. Three layers of feature processing are shown as an example, and each layer of feature processing is performed based on a high-resolution low-dimensional feature of a corresponding scale.

A process of one layer of feature processing is described below by using the module 10-231 as an example.

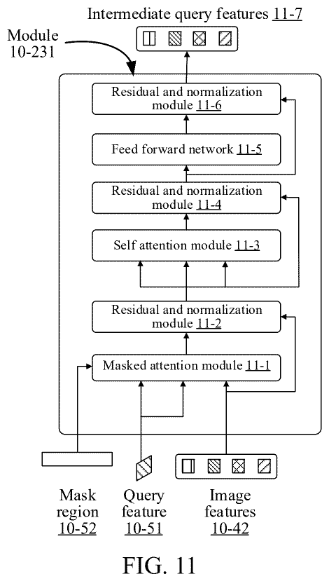

FIG. 11 is an example diagram of a network structure of a module according to some embodiments, and the module is configured to complete one layer of feature processing. As shown in FIG. 11, the module 10-231 in FIG. 10 includes a masked attention module 11-1, a residual and normalization (Add & Norm) module 11-2, a self attention module 11-3, a residual and normalization module 11-4, a feed forward network (FFN) 11-5, and a residual and normalization module 11-6.

The query features 10-51, the mask region 10-52, and the image feature 10-42 sequentially pass through the modules in the module 10-231, so that intermediate query features 11-7 can be obtained. The intermediate query features 11-7 are used as input to the module 10-232 in FIG. 10 with reference to the image feature 10-43.

The road surface information obtained by using the image processing method provided in some embodiments is described below.

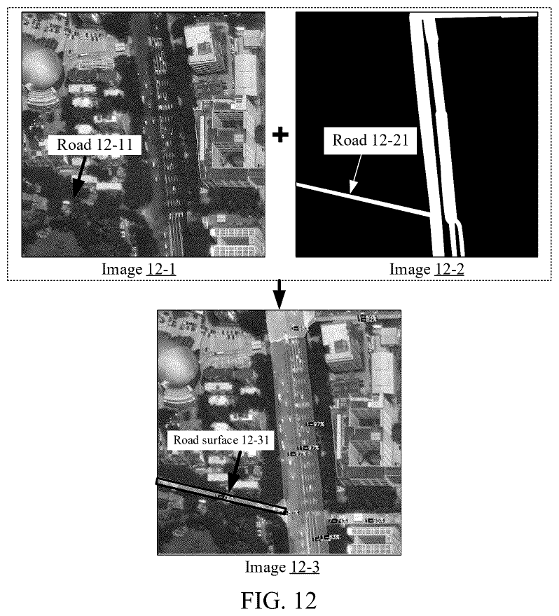

FIG. 12 is an example schematic diagram of a result of obtaining a road surface according to some embodiments. As shown in FIG. 12, an image 12-1 is a satellite image for a geographic range A. In the image 12-1, a road 12-11 is partially blocked by trees. An image 12-2 is a gray-scale image generated based on SD road network information in the geographic range A. In the image 12-2, a road 12-21 (which corresponds to the roads 12-11 in the image 12-1) is connected. A road surface is obtained with reference to the image 12-1 and the image 12-2, and a road surface 12-31 shown in an image 12-3 can be obtained. Therefore, coverage and connectivity of the road surface can be improved.

Application performed based on the road surface information obtained in some embodiments is described below.

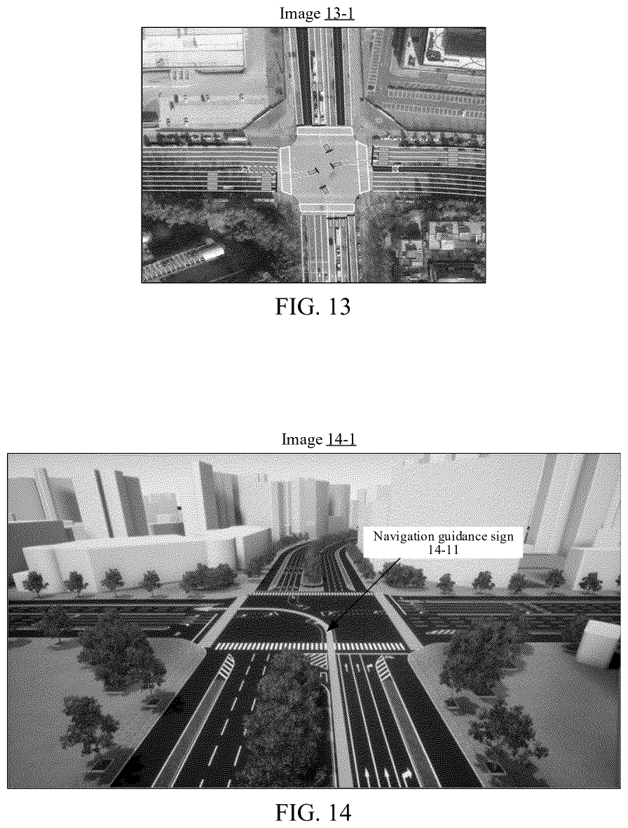

FIG. 13 is an example schematic diagram of application of road surface information according to some embodiments. As shown in FIG. 13, an image 13-1 is a rendering result of lane-level data implemented based on road surface information.

FIG. 14 is another example schematic diagram of application of road surface information according to some embodiments. As shown in FIG. 14, an image 14-1 is a road rendered based on lane-level data, and a navigation guidance sign 14-11 is further displayed on the rendered road. The navigation guidance sign 14-11 is a sign for navigating from one lane to another lane, so that navigation accuracy is improved.

In some embodiments, the road surface information is obtained with reference to the satellite image and the SD road network information, so that efficiency, coverage, and accuracy of the road surface information when there is a block in the satellite image can be improved.

The following continues to describe an example structure that is implemented as a software module and that is of the image processing apparatus 255 provided in some embodiments. In some embodiments, as shown in FIG. 2, the software module in the image processing apparatus 255 stored in the memory 250 may include:
an image obtaining module 2551, configured to obtain a live-view road image within a specified geographic range, and obtain a road network image within the specified geographic range, the live-view road image representing road imaging information within the specified geographic range, and the road network image including a road topology structure within the specified geographic range;
an image combination module 2552, configured to combine the road network image and the live-view road image, to obtain a to-be-recognized image;
a feature extraction module 2553, configured to perform feature extraction on the to-be-recognized image, to obtain a to-be-recognized feature; and
an information recognition module 2554, configured to perform road surface recognition based on the to-be-recognized feature, to obtain road surface information, the road surface information being road surface association information within the specified geographic range.

In some embodiments, the image obtaining module 2551 is further configured to obtain target road network information within the specified geographic range, where the target road network information includes a road estimation location and geometric estimation information, and the geometric estimation information includes at least one of a lane quantity range, a road width range, and a road level; and estimate a road at the road estimation location with reference to a map ratio and the geometric estimation information, to obtain the road network image.

In some embodiments, the information recognition module 2554 is further configured to determine, based on a specified instance quantity, an initial instance feature corresponding to the to-be-recognized image, where the specified instance quantity represents a quantity of specified road surfaces, the initial instance feature includes initial instance sub-features corresponding to the specified instance quantity, and each of the initial instance sub-features represents a preset feature of the specified road surface; decode the initial instance feature based on the to-be-recognized feature, to obtain a target instance feature; and perform road surface recognition based on the target instance feature, to obtain the road surface information.

In some embodiments, the information recognition module 2554 is further configured to determine the to-be-recognized feature as a 1^{st} image feature, and determine the initial instance feature as a 1^{st} instance feature; and perform the following processing by iterating from 1 to i, where i is a positive integer: upsampling an i^{th} image feature, to obtain an (i+1)^{th} image feature; obtaining an i^{th} mask region corresponding to an i^{th} instance feature; performing attention calculation based on the (i+1)^{th} image feature, the i^{th} mask region, and the i^{th} instance feature, to obtain an (i+1)^{th} instance feature; and determining, as the target instance feature, an (L+1)^{th} instance feature obtained by iterating i, where L represents a quantity of iterations of i.

In some embodiments, the information recognition module 2554 is further configured to predict an instance class based on the target instance feature, to obtain a road surface instance; upsample an (L+1)^{th} image feature, to obtain a target image feature; fuse the target image feature and the target instance feature, to obtain a mask feature; and predict information about the road surface instance based on the mask feature, to obtain the road surface information.

In some embodiments, the information recognition module 2554 is further configured to perform masked attention calculation based on the (i+1)^{th} image feature, the i^{th} mask region, and the i^{th} instance feature, to obtain an (i+1)^{th} initial feature; perform self attention calculation based on the (i+1)^{th} initial feature, to obtain an (i+1)^{th} to-be-processed feature; and perform feed-forward propagation based on the (i+1)^{th} to-be-processed feature, to obtain the (i+1)^{th} instance feature, where the attention calculation includes the masked attention calculation, the self attention calculation, and the feed-forward propagation.

In some embodiments, the feature extraction and the road surface recognition are obtained by using a road recognition model. The image processing apparatus 255 further includes a model training module 2555, configured to obtain a sample image and a road surface label corresponding to the sample image, where the sample image is obtained based on a sample live-view road image and a sample road network image; make a prediction based on the sample image by using a to-be-trained model, to obtain predicted road surface information, where the to-be-trained model is a to-be-trained neural network model for predicting road surface association information; and train the to-be-trained model based on a difference between the predicted road surface information and the road surface label, to obtain the road recognition model.

In some embodiments, the image processing apparatus 255 further includes a model optimization module 2556, configured to obtain a new sample image and a new road surface label corresponding to the new sample image; make a prediction based on the new sample image by using the road recognition model, to obtain new predicted road surface information; and optimize the road recognition model based on a difference between the new predicted road surface information and the new road surface label, to obtain a target road recognition model, where the target road recognition model is for predicting road surface association information of a new to-be-recognized image.

In some embodiments, the road surface information includes at least one piece of the following information: a road surface form, a road surface size, a road surface location, a quantity of lanes, a lane width, a lane material, a lane location, a lane form, and a road sign.

In some embodiments, the image processing apparatus 255 further includes an information application module 2557, configured to render a road within the specified geographic range based on the road surface information, and display a navigation guidance sign on the rendered road; or determine positioning information based on the road surface information, where the positioning information is a lane location.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

Some embodiments provide a computer program product. The computer program product includes computer-executable instructions or a computer program. The computer-executable instructions or computer program is stored in a computer-readable storage medium. A processor of an electronic device reads the computer-executable instructions or computer program from the computer-readable storage medium, and executes the computer-executable instructions or computer program, to enable the electronic device to perform the image processing method in some embodiments.

Some embodiments provide a computer-readable storage medium, having computer-executable instructions or a computer program stored therein. When the computer-executable instructions or computer program is executed by a processor, the processor is enabled to perform the image processing method provided in some embodiments, for example, the image processing method shown in FIG. 3.

In some embodiments, the computer-readable storage medium may be a memory such as a ferroelectric random access memory (FRAM), a ROM, a flash memory, a magnetic surface memory, an optical disc, or a compact disc read-only memory (CD-ROM), or may be various devices including one or any combination of the foregoing memories.

In some embodiments, the computer-executable instructions may be in a form of a program, software, a software module, a script, or code, written in a programming language of any form (including a compiled or interpreted language, or a declarative or procedural language), and may be deployed in any form, including being deployed as a stand-alone program or as a module, a component, a subroutine, or another unit for use in a computing environment.

In an example, the computer-executable instructions may, but do not necessarily correspond to, a file in a file system, and may be stored as a part of a file having another program or data stored therein. For example, the computer-executable instructions are stored in one or more scripts in a hypertext markup language (HTML) text, stored in a single file dedicated to a discussed program, or stored in a plurality of collaborative files (for example, files having one or more modules, subprograms, or code parts).

In an example, the computer-executable instructions may be deployed on an electronic device for execution (where in this case, the electronic device is an image processing device), or may be executed on a plurality of electronic devices located at a same location (where in this case, the plurality of electronic devices located at the same location are image processing devices). The computer-executable instructions may be executed on a plurality of electronic devices that are connected through a communication network and that are distributed at a plurality of locations (where in this case, the plurality of electronic devices that are connected through the communication network and that are distributed at the plurality of locations are image processing devices).

In some embodiments, relevant data such as the live-view road image and the sample live-view road image is involved. When some embodiments are applied to a product or technology, user permission or consent may need to be obtained, and collection, use, and processing of the relevant data should comply with relevant laws, regulations, and standards of relevant countries and regions.

In the process in which the road surface information of the road within the specified geographic range is obtained, the road surface information is obtained not only based on the live-view road image of the road within the specified geographic range, but also with reference to the road network image of the road within the specified geographic range. The live-view road image can accurately describe the information included on the road, and the road network image can completely describe the topological connectivity of the road. Therefore, when the road surface information is obtained with reference to the live-view road image and the road network image, the connectivity of the road can be improved while it is ensured that the road surface information is accurate, so that the accuracy, the efficiency, and the coverage of the obtained road surface information can be improved.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, executed by an electronic device, the image processing method comprising:
obtaining a live-view road image comprising road imaging information within a geographic range, and obtaining a road network image comprising a road topology structure within the geographic range;
obtaining a to-be-recognized image by combining the road network image and the live-view road image;
obtaining a to-be-recognized feature by performing feature extraction on the to-be-recognized image;
obtaining road surface information, within the geographic range, comprising road surface association information, by performing road surface recognition based on the to-be-recognized feature; and
performing at least one from among:
rendering a road within the geographic range based on the road surface information, and displaying a navigation guidance sign on the rendered road; and
determining positioning information based on the road surface information, wherein the positioning information is a lane location.

2. The image processing method according to claim 1, wherein the obtaining the road network image comprises:
obtaining target road network information, within the geographic range, comprising a road estimation location and geometric estimation information, the geometric estimation information comprising at least one from among a lane quantity range, a road width range, and a road level; and
obtaining the road network image by estimating a road to be at the road estimation location based on a map ratio and the geometric estimation information.

3. The image processing method according to claim 1, wherein the obtaining the road surface information comprises:
determining, based on an instance quantity, an initial instance feature corresponding to the to-be-recognized image, wherein the instance quantity indicates a quantity of road surfaces, the initial instance feature comprises a plurality of initial instance sub-features corresponding to the instance quantity, and the plurality of initial instance sub-features indicate a plurality of preset features of the road surfaces;
obtaining a target instance feature by decoding the initial instance feature based on the to-be-recognized feature; and
obtaining the road surface information by performing road surface recognition based on the target instance feature.

4. The image processing method according to claim 3, wherein the obtaining the target instance feature comprises:
determining the to-be-recognized feature as a 1^{st} image feature, and determining the initial instance feature as a 1^{st} instance feature; and
iteratively performing from 1 to i, wherein i is a positive integer:
obtaining an (i+1)^{th} image feature by upsampling an i^{th} image feature;
obtaining an i^{th} mask region corresponding to an i^{th} instance feature;
obtaining an (i+1)^{th} instance feature by performing attention calculation based on the (i+1)^{th} image feature, the i^{th} mask region, and the i^{th} instance feature; and
determining, as the target instance feature, an (L+1)^{th} instance feature obtained by iterating i, wherein L represents a quantity of iterations of i.

5. The image processing method according to claim 4, wherein the obtaining the road surface information comprises:
obtaining a road surface instance by predicting an instance class based on the target instance feature;
obtaining a target image feature by upsampling an (L+1)^{th} image feature;
obtaining a mask feature by fusing the target image feature and the target instance feature; and
obtaining the road surface information by predicting information about the road surface instance based on the mask feature.

6. The image processing method according to claim 4, wherein the obtaining the (i+1)^{th} instance feature comprises:
obtaining an (i+1)^{th} initial feature by performing a masked attention calculation based on the (i+1)^{th} image feature, the i^{th} mask region, and the i^{th} instance feature;
obtaining an (i+1)^{th} to-be-processed feature by performing a self-attention calculation based on the (i+1)^{th} initial feature; and
obtaining the (i+1)^{th} instance feature by performing feed-forward propagation based on the (i+1)^{th} to-be-processed feature, to obtain the (i+1)^{th} instance feature.

7. The image processing method according to claim 1, wherein the feature extraction and the road surface recognition are obtained based on a road recognition model, and
wherein the road recognition model is obtained through training comprising:
obtaining a first sample image based on a sample live-view road image and a sample road network image, and obtaining a first road surface label corresponding to the first sample image;
obtaining first predicted road surface information based on a prediction from the first sample image using a to-be-trained model comprising a to-be-trained neural network model for predicting road surface association information; and
obtaining the road recognition model by training the to-be-trained model based on a difference between the first predicted road surface information and the first road surface label.

8. The image processing method according to claim 7, wherein the image processing method further comprises, based on obtaining the road recognition model:
obtaining a second sample image and a second road surface label corresponding to the second sample image;
obtaining second predicted road surface information based on a prediction from the second sample image using the road recognition model; and
obtaining a target road recognition model, for predicting road surface association information of a second to-be-recognized image, by refining the road recognition model based on a difference between the second predicted road surface information and the second road surface label.

9. The image processing method according to claim 1, wherein the road surface information comprises at least one from among: a road surface form, a road surface size, a road surface location, a quantity of lanes, a lane width, a lane material, a lane location, a lane form, and a road sign.

10. The image processing method according to claim 1, wherein the lane location corresponds to a position of an object on a road, the object comprising a pedestrian or a vehicle.

11. An image processing apparatus, comprising:
at least one memory configured to store computer program code; and
at least one processor configured to read the program code and operate as instructed by the program code, the program code comprising:
image obtaining code configured to cause at least one of the at least one processor to:
obtain a live-view road image comprising road imaging information within a geographic range; and
obtain a road network image comprising a road topology structure within the geographic range;
image combination code configured to cause at least one of the at least one processor to obtain a to-be-recognized image by combining the road network image and the live-view road image;
feature extraction code configured to cause at least one of the at least one processor to obtain a to-be-recognized feature by performing feature extraction on the to-be-recognized image;
information recognition code configured to cause at least one of the at least one processor to obtain road surface information, within the geographic range, comprising road surface association information, by performing road surface recognition based on the to-be-recognized feature; and
performing code configured to cause at least one of the at least one processor to:
render a road within the geographic range based on the road surface information, and output, to a display, a navigation guidance sign on the rendered road; or
determine positioning information based on the road surface information, wherein the positioning information is a lane location.

12. The image processing apparatus according to claim 11, wherein the image obtaining code is further configured to cause at least one of the at least one processor to:
obtain target road network information, within the geographic range, comprising a road estimation location and geometric estimation information, the geometric estimation information comprising at least one from among a lane quantity range, a road width range, and a road level; and
obtain the road network image by estimating a road to be at the road estimation location based on a map ratio and the geometric estimation information.

13. The image processing apparatus according to claim 11, wherein the information recognition code is further configured to cause at least one of the at least one processor to:
determine, based on an instance quantity, an initial instance feature corresponding to the to-be-recognized image, wherein the instance quantity indicates a quantity of road surfaces, the initial instance feature comprises a plurality of initial instance sub-features corresponding to the instance quantity, and the plurality of initial instance sub-features indicate a plurality of preset features of the road surfaces;
obtain a target instance feature by decoding the initial instance feature based on the to-be-recognized feature; and
obtain the road surface information by performing road surface recognition based on the target instance feature.

14. The image processing apparatus according to claim 13, wherein the information recognition code is further configured to cause at least one of the at least one processor to:
determine the to-be-recognized feature as a 1^{st} image feature, and determine the initial instance feature as a 1^{st} instance feature; and
iteratively perform from 1 to i, wherein i is a positive integer:
obtaining an (i+1)^{th} image feature by upsampling an i^{th} image feature;
obtaining an i^{th} mask region corresponding to an i^{th} instance feature;
obtaining an (i+1)^{th} instance feature by performing attention calculation based on the (i+1)^{th} image feature, the i^{th} mask region, and the i^{th} instance feature; and
determining, as the target instance feature, an (L+1)^{th} instance feature obtained by iterating i, wherein L represents a quantity of iterations of i.

15. The image processing apparatus according to claim 14, wherein the information recognition code is further configured to cause at least one of the at least one processor to:
obtain a road surface instance by predicting an instance class based on the target instance feature;
obtain a target image feature by upsampling an (L+1)^{th} image feature;
obtain a mask feature by fusing the target image feature and the target instance feature; and
obtain the road surface information by predicting information about the road surface instance based on the mask feature.

16. The image processing apparatus according to claim 14, wherein the information recognition code is further configured to cause at least one of the at least one processor to:
obtain an (i+1)^{th} initial feature by performing a masked attention calculation based on the (i+1)^{th} image feature, the i^{th} mask region, and the i^{th} instance feature;
obtain an (i+1)^{th} to-be-processed feature by performing a self-attention calculation based on the (i+1)^{th} initial feature; and
obtain the (i+1)^{th} instance feature by performing feed-forward propagation based on the (i+1)^{th} to-be-processed feature, to obtain the (i+1)^{th} instance feature.

17. The image processing apparatus according to claim 11, wherein the feature extraction and the road surface recognition are obtained based on a road recognition model,
wherein the road recognition model is obtained through training, and
wherein the program code further comprises training code configured to cause at least one of the at least one processor to:
obtain a first sample image based on a sample live-view road image and a sample road network image, and obtaining a first road surface label corresponding to the first sample image;
obtain first predicted road surface information based on a prediction from the first sample image using a to-be-trained model comprising a to-be-trained neural network model for predicting road surface association information; and
obtain the road recognition model by training the to-be-trained model based on a difference between the first predicted road surface information and the first road surface label.

18. The image processing apparatus according to claim 17, wherein the program code further comprises target road recognition code configured to cause at least one of the at least one processor to:
obtain a second sample image and a second road surface label corresponding to the second sample image;
obtain second predicted road surface information based on a prediction from the second sample image using the road recognition model; and
obtain a target road recognition model, for predicting road surface association information of a second to-be-recognized image, by refining the road recognition model based on a difference between the second predicted road surface information and the second road surface label.

19. The image processing apparatus according to claim 11, wherein the road surface information comprises at least one from among: a road surface form, a road surface size, a road surface location, a quantity of lanes, a lane width, a lane material, a lane location, a lane form, and a road sign.

20. A non-transitory computer-readable storage medium, storing computer code which, when executed by at least one processor, causes the at least one processor to at least:
obtain a live-view road image comprising road imaging information within a geographic range, and obtain a road network image comprising a road topology structure within the geographic range;
obtain a to-be-recognized image by combining the road network image and the live-view road image;
obtain a to-be-recognized feature by performing feature extraction on the to-be-recognized image;
obtain road surface information, within the geographic range, comprising road surface association information, by performing road surface recognition based on the to-be-recognized feature,
wherein the computer code, when executed by the at least one processor, further causes the at least one processor to:
render a road within the geographic range based on the road surface information, and output, to a display, a navigation guidance sign on the rendered road; or
determine positioning information based on the road surface information, wherein the positioning information is a lane location.
